(19) United States
(12) Patent Application Publication
(10) Pub. No.: US 2026/0072893 A1
(43) Pub. Date: Mar. 12, 2026

(54) SYSTEMS AND METHODS FOR KEY-BASED DATA RECONCILIATION

(71) Applicant: JPMORGAN CHASE BANK, N.A., New York, NY (US)

(72) Inventors: Liangzhao ZENG, Cupertino, CA (US); Jimmy HONG, Belmont, CA (US); Vincent HONG, Sunnyvale, CA (US)

(21) Appl. No.: 18/827,146

(22) Filed: Sep. 6, 2024

(51) Int. Cl. G06F 16/22

(52) U.S. Cl. CPC G06F 16/2255; G06F 16/221

(57) ABSTRACT

A method may include: identifying source dataset key columns in a source dataset; forming a sample dataset of a subset of the source dataset key columns; generating a hashed unique key column value for each row in the sample dataset; generating a hashed row value for each row in the sample dataset; generating a hashed column value for each cell in each row of the sample dataset; identifying target dataset key columns in a target dataset and generating a hashed unique key column value for each row; searching for the hashed unique key column values in the target dataset; generating a hashed row value for a matching row in the target dataset; generating a hashed column value for each cell in the row in the target dataset; and returning an identity of a column name having a hashed column value matching that of the source dataset.

### BACKGROUND OF THE INVENTION

### 1. Field Of The Invention

Embodiments generally relate to systems and methods for key-based data reconciliation.

### 2. Description of the Related Art

Data reconciliation often involves the brute-force comparison of one dataset to another, or even of a smaller subset (e.g., randomly sampled) from the first dataset to compare to the second dataset. In some cases, some records cannot be found in the target dataset. These processes, however, cannot provide diagnosis information about the deviation between the source and target records.

### SUMMARY OF THE INVENTION

Systems and methods for key-based data reconciliation are disclosed. According to an embodiment, a method may include: (1) identifying, by a computer program, source dataset key columns in a source dataset that uniquely identify records in the source dataset; (2) selecting, by the computer program, a subset of rows in the source dataset key columns to form a sample dataset; (3) generating, by the computer program, a hashed unique key column value for each row in the sample dataset; (4) generating, by the computer program, a hashed row value for each row in the sample dataset; (5) generating, by the computer program, a hashed column value for each cell in each row of the sample dataset; (6) identifying, by the computer program, target dataset key columns in a target dataset that uniquely identify records in the target dataset; (7) generating, by the computer program, a hashed unique key column value for each row in the target dataset; (8) searching, by the computer program, the hashed unique key column values for each row in the target dataset for the hashed unique key column values from the sample dataset; (9) generating, by the computer program, a hashed row value for a row in the target dataset that matches one of the hashed unique key column value from the sample dataset; (10) generating, by the computer program, a hashed column value for each cell in the row in the target dataset that matches one of the hashed unique key column value from the sample dataset; and (11) returning, by the computer program, an identity of a column name having a hashed column value matching the hashed column value from the source dataset.

In one embodiment, the hashed unique key column value may include a hash of a cell in the key column.

In one embodiment, the hashed unique key column value may include a hash of a cell in a plurality of the key columns.

In one embodiment, the step of generating, by the computer program, a hashed row value for each row in the sample dataset may include: concatenating, by the computer program, values of the cells in each row in the sample dataset; and hashing, by the computer program, the concatenated values with the unique key column value for the row.

In one embodiment, the step of generating, by the computer program, the hashed column value for each cell in each row of the sample dataset may include: hashing, by the computer program, each cell with the unique key column value for the row.

In one embodiment, the method may also include: returning, by the computer program, an identification of a row in the sample dataset that does not have a matching hashed unique key column value in the target dataset.

In one embodiment, the method may also include: returning, by the computer program, an identification of a row in the sample dataset that has a matching hashed row value in the target dataset.

In one embodiment, the step of generating, by the computer program, the hashed column value for each cell in the row in the target dataset that matches one of the hashed unique key column value from the sample dataset may be in response to the hashed row value for the row not matching.

In one embodiment, a number of rows in the sample dataset may be based on a size of the source dataset.

In one embodiment, the method may also include: copying, by the computer program, missing cells from the source dataset to the target dataset.

According to another embodiment, a non-transitory computer readable storage medium, including instructions stored thereon, which when read and executed by one or more computer processors, cause the one or more computer processors to perform steps including: identifying source dataset key columns in a source dataset that uniquely identify records in the source dataset; selecting a subset of rows in the source dataset key columns to form a sample dataset; generating a hashed unique key column value for each row in the sample dataset; generating a hashed row value for each row in the sample dataset; generating a hashed column value for each cell in each row of the sample dataset; identifying target dataset key columns in a target dataset that uniquely identify records in the target dataset; generating a hashed unique key column value for each row in the target dataset; searching the hashed unique key column values for each row in the target dataset for the hashed unique key column values from the sample dataset; generating a hashed row value for a row in the target dataset that matches one of the hashed unique key column value from the sample dataset; generating a hashed column value for each cell in the row in the target dataset that matches one of the hashed unique key column value from the sample dataset; and returning an identity of a column name having a hashed column value matching the hashed column value from the source dataset.

In one embodiment, the hashed unique key column value may include a hash of a cell in the key column.

In one embodiment, the hashed unique key column value may include a hash of a cell in a plurality of the key columns.

In one embodiment, generating a hashed row value for each row in the sample dataset may include instructions stored thereon, which when read and executed by the one or more computer processors, cause the one or more computer processors to perform steps including: concatenating values of the cells in each row in the sample dataset; and hashing the concatenated values with the unique key column value for the row.

In one embodiment, generating the hashed column value for each cell in each row of the sample dataset may include instructions stored thereon, which when read and executed by the one or more computer processors, cause the one or more computer processors to perform steps including: hashing each cell with the unique key column value for the row.

In one embodiment, the non-transitory computer readable storage medium may also instructions stored thereon, which when read and executed by the one or more computer processors, cause the one or more computer processors to perform steps including: returning an identification of a row in the sample dataset that does not have a matching hashed unique key column value in the target dataset.

In one embodiment, the non-transitory computer readable storage medium may also include instructions stored thereon, which when read and executed by the one or more computer processors, cause the one or more computer processors to perform steps including: returning an identification of a row in the sample dataset that has a matching hashed row value in the target dataset.

In one embodiment, generating the hashed column value for each cell in the row in the target dataset that matches one of the hashed unique key column value from the sample dataset may be in response to the hashed row value for the row not matching.

In one embodiment, a number of rows in the sample dataset may be based on a size of the source dataset.

In one embodiment, the non-transitory computer readable storage medium may also include instructions stored thereon, which when read and executed by the one or more computer processors, cause the one or more computer processors to perform steps including: copying missing cells from the source dataset to the target dataset.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for key-based data reconciliation according to an embodiment;

FIGS. 2A and 2B depict a method for key-based data reconciliation according to an embodiment;

FIG. 3 depicts an exemplary computing system for implementing aspects of the present disclosure.

### DETAILED DESCRIPTION OF PREFERRED EMBODIMENTS

Embodiments generally relate to systems and methods for key-based data reconciliation.

Embodiments may search for key columns as a base when performing random sampling as well as sample record search. After the search, for those key matched records from source and target dataset, a column level comparison is performed, wherein the column name with some sample value can be reported if there is any difference between the source and target records.

Thus, embodiments may identify columns that have a difference between the source record and the target record.

Embodiments may provide at least some of the following technical advantages: (1) identify the key columns from the source dataset systematically (key columns contain minimal information that can be used to uniquely identify the rows; for example, any unique sequence id can be considered as key columns); (2) since the sampling is only performed on the key columns, full text loading is not required when performing the sampling, which greatly reduces the system overhead and cost; (3) searching the sample records from the source dataset in the target dataset use those key columns only instead of full text search, which greatly reduce the cost of searching by loading the key columns only; (4) a column level comparison is performed in those matched records only, thereby minimizing system overhead and cost; and (5) column level comparison results assist in diagnosing issues during the data migration.

As used herein, a key column is a column that has a unique value that can be used to identify the row. An example of such column can be a unique sequence number that is generated for each transaction.

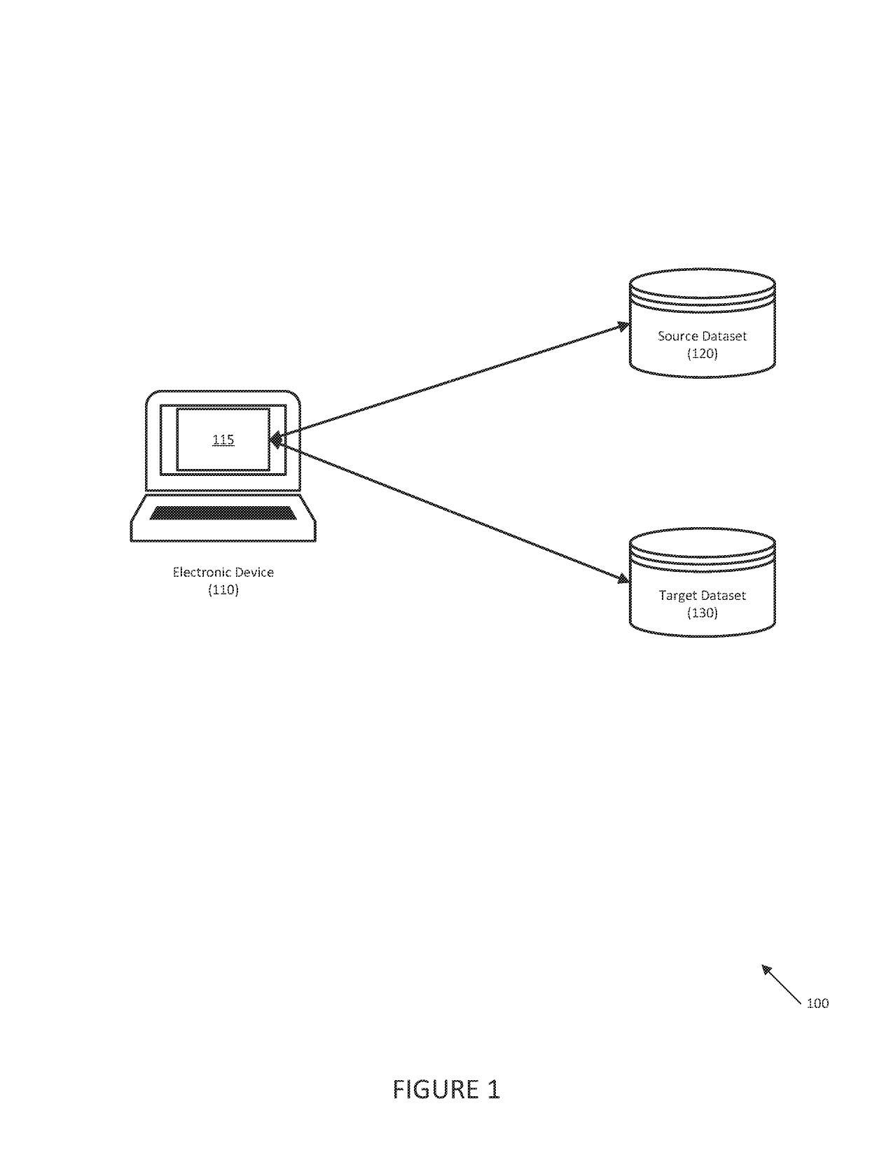

FIG. 1 depicts a system for key-based data reconciliation according to an embodiment. System 100 may include electronic device 110, which may be a server (e.g., physical server and/or cloud-based server), a computer (e.g., desktop, laptop, notebook, tablet, etc.), a smart device (e.g., smartphone, smart watch, etc.), an Internet of Things (IoT) appliance, etc. Electronic device 110 may execute computer program 115, such as a data reconciliation computer program.

Computer program 115 may provide functionality including, for key column searching, random sampling, record searching, and comparison.

Computer program 115 may interface with a plurality of datasets, such as source dataset 120 and target dataset 130. Although source dataset 120 and target dataset 130 are depicted as being outside of electronic device 110, it should be noted that these datasets may be located in storage on electronic device 110, on another electronic device (not shown), in network storage (not shown), in the cloud (not shown), etc. It should further be noted that these datasets may be located separately from each other.

In one embodiment, source dataset 120 and target dataset 130 may be tables. For example, target dataset 130 may have been copied from source dataset 120 and computer program 115 may be used to reconcile any differences between the two datasets.

Computer program 115 may include, for example, a key column search engine, a random sample, and a record searching and comparison engine.

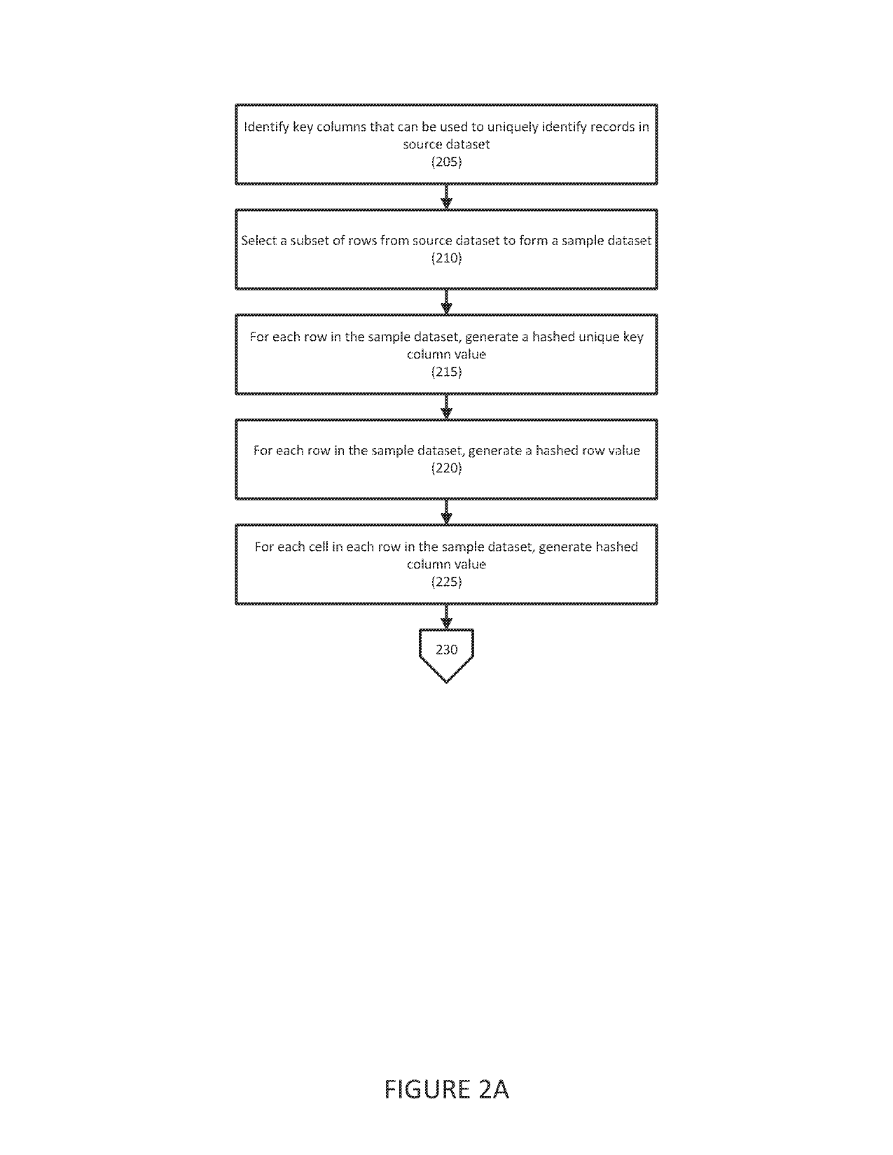

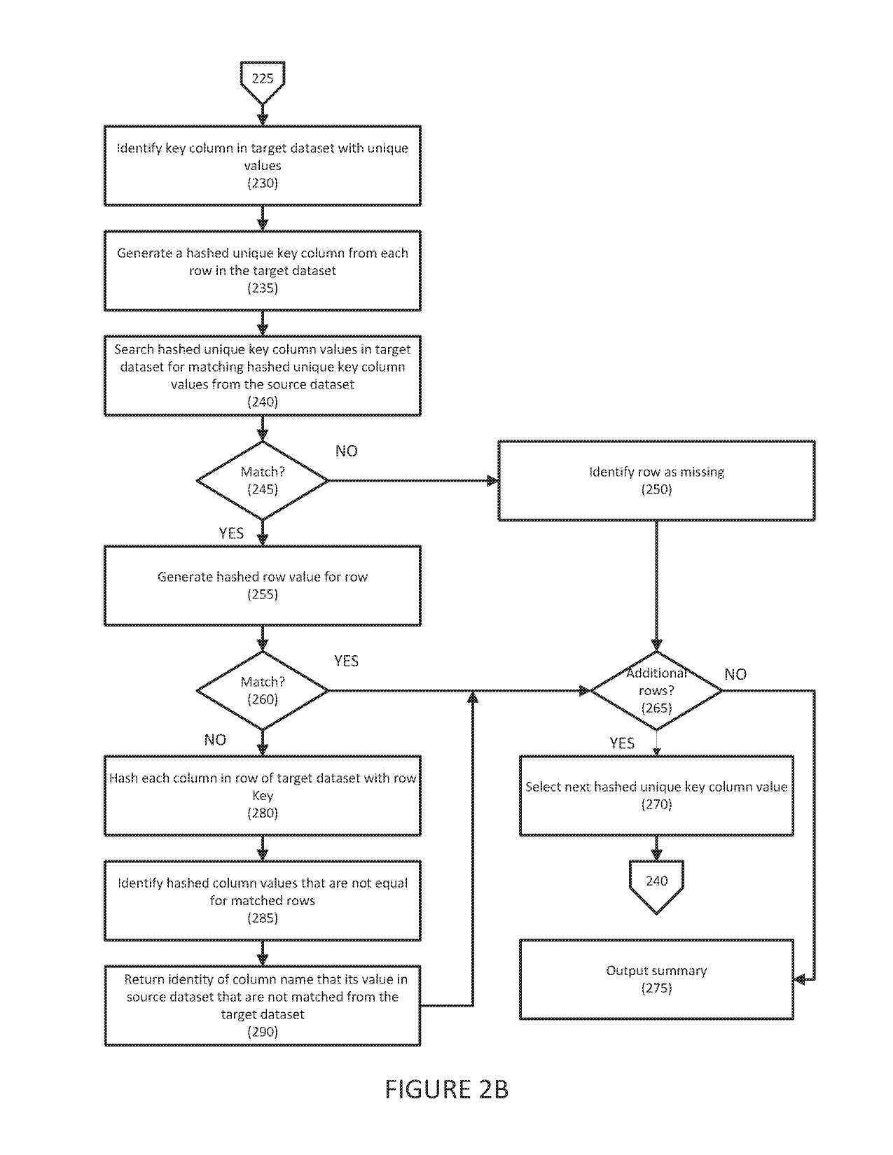

Referring to FIGS. 2A and 2B, a method for key-based data reconciliation is disclosed according to an embodiment.

In step 205, a computer program, such as a data reconciliation computer program, may identify key columns in a source data set that can be used to uniquely identify records in the source dataset. For example, the computer program may identify columns that include unique identifiers, such as a student number, an employee number, a social security number, etc. as key columns.

In step 210, the computer program may select a subset of rows from the key columns to form a sample dataset. Each row may have one or more cells. The number of rows in the sample dataset may be based on the size (e.g., row count) of the source dataset.

In step 215, for each row in the sample dataset, the computer program may hash one or more of the cells for the key columns in that row. This results in a hashed unique key column value for each row.

For example, if the hashed unique key column value is based on one cell, only the one cell is hashed to form the hashed unique key column value. If the hashed unique key column value is based on two cells, the cells may be hashed together to form the hashed unique key column value.

In step 220, the computer program may concatenate the values for the cells in each row of the sample dataset, and may hash the hashed unique key column value and the concatenated cells together. This results in a hashed row value for each row.

In step 225, the computer program may hash each cell in each row with the hashed unique key column value. This results in a hashed column value for each cell in the sample dataset.

In step 230, the computer program may identify key column(s) in a target dataset that may match the key column(s) in the source dataset. For example, the computer program may identify column(s) in the target dataset that have labels, names, etc. that match the key column(s).

In one embodiment, the key column(s) in the source dataset may be the same key column(s) as in the sample dataset.

In step 235, for the key columns in the target dataset, the computer program may hash all of the records (i.e., all cells) together in one or more of key columns. This generates a hashed unique key column value for each row in the target dataset.

For example, if the hashed unique key column value for the sample dataset was based on one key column, the hashed unique key column value for the target dataset will also be based on the same key column. If the hashed unique key column value for the sample dataset was based on more than one key columns, the hashed unique key column value for the target dataset will also be based on the same key columns.

In one embodiment, the same number of key columns that were used in the source dataset may also be used in the target dataset.

In step 240, the computer program may cycle through the hashed unique key column values in the source dataset to find a matching hashed unique key column value in the target dataset. Matching hashed unique key column values may identify a row in the target dataset that may match one in the source dataset.

In step 245, the computer program may search for a matching hashed unique key column value from the source dataset that matches the current hashed unique key column value. If there is not a match, in step 250, the computer program may identify the row as missing in the target dataset.

If there is a match, in step 255, the computer program may generate a hashed row value for the row. Similar to step 220, the computer program may concatenate the cells in the row, and may hash the hashed unique key column value with the concatenated cells.

In step 260, the computer program may compare the hashed row value for the row in the target dataset to the hashed row value for the row in the source dataset. If there is a match, the process may continue to step 265.

In step 265, the computer program may check to see if it has evaluated all hashed unique key column values. If there are additional hashed unique key column values to consider, in step 270, the computer program may cycle to the next hashed unique key column value and may return to step 240.

If, in step 260, the hashed row values do not match, in step 280, the computer program may hash each column (cell) in the row with the hashed unique key column value for the row. Similar to step 225, the computer program may hash each cell in the row with the hashed unique key column value.

In step 285, for each matched pair of rows, the computer program may identify hashed column values that are not equal. This indicates cells in the target dataset that are different from cells in the source dataset.

In step 290, the computer program may return the column name that does not match the target dataset, and the process may then return to step 265.

If, in step 265, all rows from the sample dataset have been checked against the target dataset, in step 275, the computer program may output a summary, such as an identification of rows that are missing and rows that are present but have changed records. In one embodiment, the computer program may also identify rows that are confirmed to be unchanged.

In one embodiment, if the target dataset does not match the source dataset, the computer program may optionally execute an automated action, such as self-healing to re-copy the rows and/or records that are missing or do not match from the sample dataset to the target dataset. In another embodiment, the computer program may perform a more thorough review by fully comparing the source dataset to the target dataset.

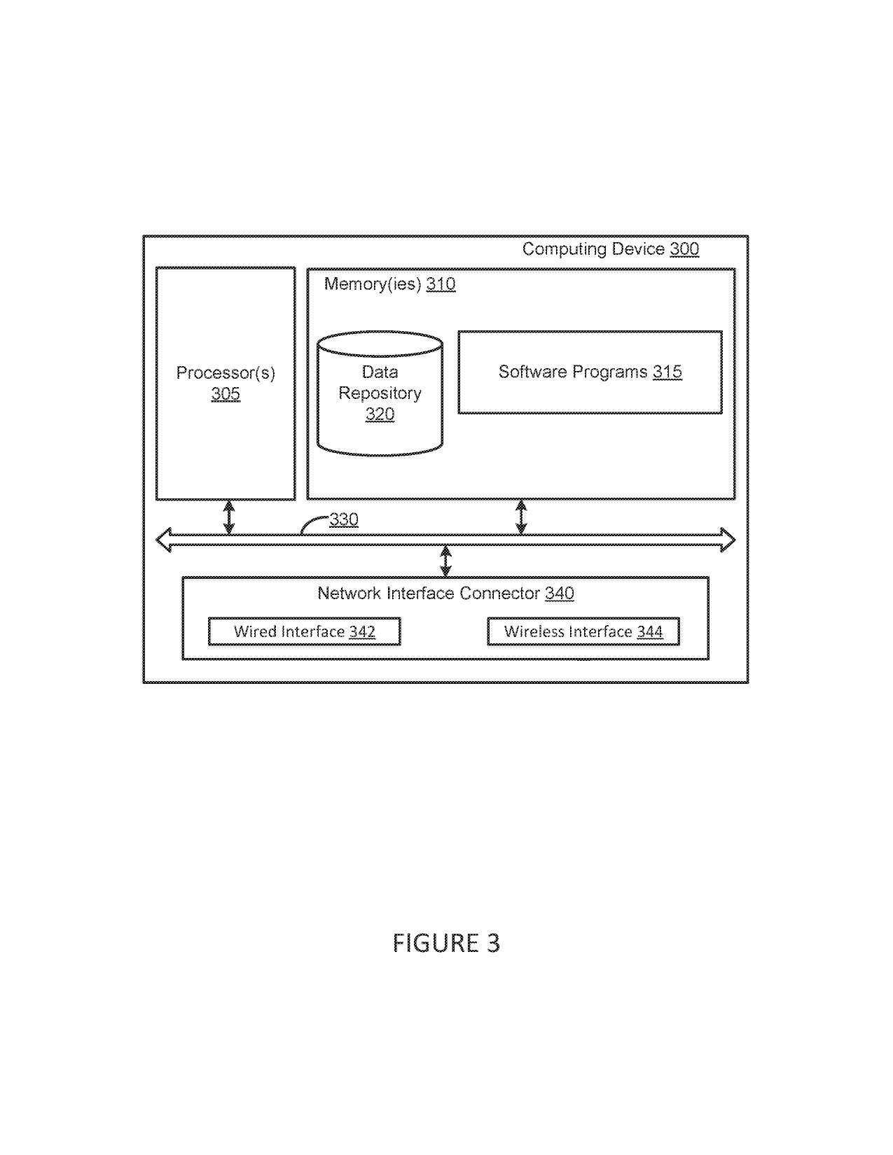

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
identifying, by a computer program, source dataset key columns in a source dataset that uniquely identify records in the source dataset;
selecting, by the computer program, a subset of rows in the source dataset key columns to form a sample dataset;
generating, by the computer program, a first hashed unique key column value for each row in the sample dataset;
generating, by the computer program, a first hashed row value for each row in the sample dataset;
generating, by the computer program, a first hashed column value for each cell in each row of the sample dataset;
identifying, by the computer program, target dataset key columns in a target dataset that uniquely identify records in the target dataset;
generating, by the computer program, a second hashed unique key column value for each row in the target dataset;
searching, by the computer program, the second hashed unique key column values for each row in the target dataset for the first hashed unique key column values from the sample dataset;
generating, by the computer program, a second hashed row value for a row in the target dataset that matches one of the first hashed unique key column values from the sample dataset;
generating, by the computer program, a second hashed column value for each cell in the row in the target dataset that matches one of the first hashed unique key column values from the sample dataset; and
returning, by the computer program, a column name having a second hashed column value matching the first hashed column value from the source dataset.

2. The method of claim 1, wherein the first hashed unique key column value comprises a hash of a cell in the key column.

3. The method of claim 1, wherein the first hashed unique key column value comprises a hash of a cell in a plurality of the key columns.

4. The method of claim 1, wherein the step of generating, by the computer program, the first hashed row value for each row in the sample dataset comprises:
concatenating, by the computer program, values of the cells in each row in the sample dataset; and
hashing, by the computer program, the concatenated values with the unique key column value for the row.

5. The method of claim 1, wherein the step of generating, by the computer program, the first hashed column value for each cell in each row of the sample dataset comprises:
hashing, by the computer program, each cell with the unique key column value for the row.

6. The method of claim 1, further comprising:
returning, by the computer program, an identification of a row in the sample dataset that does not have a matching second hashed unique key column value in the target dataset.

7. The method of claim 1, further comprising:
returning, by the computer program, an identification of a row in the sample dataset that has a matching second hashed row value in the target dataset.

8. The method of claim 1, wherein the step of generating, by the computer program, the second hashed column value for each cell in the row in the target dataset that matches one of the first hashed unique key column value from the sample dataset is in response to the first hashed row value for the row not matching.

9. The method of claim 1, wherein a number of rows in the sample dataset is based on a size of the source dataset.

10. The method of claim 1, further comprising:
copying, by the computer program, missing cells from the source dataset to the target dataset.

11. A non-transitory computer readable storage medium, including instructions stored thereon, which when read and executed by one or more computer processors, cause the one or more computer processors to perform steps comprising:
identifying source dataset key columns in a source dataset that uniquely identify records in the source dataset;
selecting a subset of rows in the source dataset key columns to form a sample dataset;
generating a first hashed unique key column value for each row in the sample dataset;
generating a first hashed row value for each row in the sample dataset;
generating a first hashed column value for each cell in each row of the sample dataset;
identifying target dataset key columns in a target dataset that uniquely identify records in the target dataset;
generating a second hashed unique key column value for each row in the target dataset;
searching the second hashed unique key column values for each row in the target dataset for the first hashed unique key column values from the sample dataset;
generating a second hashed row value for a row in the target dataset that matches one of the first hashed unique key column values from the sample dataset;
generating a second hashed column value for each cell in the row in the target dataset that matches one of the first hashed unique key column values from the sample dataset; and
returning an identity of a column name having a second hashed column value matching the first hashed column value from the source dataset.

12. The non-transitory computer readable storage medium of claim 11, wherein the first hashed unique key column value comprises a hash of a cell in the key column.

13. The non-transitory computer readable storage medium of claim 11, wherein the first hashed unique key column value comprises a hash of a cell in a plurality of the key columns.

14. The non-transitory computer readable storage medium of claim 11, wherein generating the first hashed row value for each row in the sample dataset comprises instructions stored thereon, which when read and executed by the one or more computer processors, cause the one or more computer processors to perform steps comprising:
concatenating values of the cells in each row in the sample dataset; and
hashing the concatenated values with the unique key column value for the row.

15. The non-transitory computer readable storage medium of claim 11, wherein generating the first hashed column value for each cell in each row of the sample dataset comprises instructions stored thereon, which when read and executed by the one or more computer processors, cause the one or more computer processors to perform steps comprising:
hashing each cell with the unique key column value for the row.

16. The non-transitory computer readable storage medium of claim 11, further including instructions stored thereon, which when read and executed by the one or more computer processors, cause the one or more computer processors to perform steps comprising:
returning an identification of a row in the sample dataset that does not have a matching second hashed unique key column value in the target dataset.

17. The non-transitory computer readable storage medium of claim 11, further including instructions stored thereon, which when read and executed by the one or more computer processors, cause the one or more computer processors to perform steps comprising:
returning an identification of a row in the sample dataset that has a matching second hashed row value in the target dataset.

18. The non-transitory computer readable storage medium of claim 11, wherein generating the second hashed column value for each cell in the row in the target dataset that matches one of the first hashed unique key column values from the sample dataset is in response to the first hashed row value for the row not matching.

19. The non-transitory computer readable storage medium of claim 11, wherein a number of rows in the sample dataset is based on a size of the source dataset.

20. The non-transitory computer readable storage medium of claim 11, further including instructions stored thereon, which when read and executed by the one or more computer processors, cause the one or more computer processors to perform steps comprising:
copying missing cells from the source dataset to the target dataset.
